(19) United States
(12) Patent Application Publication
(10) Pub. No.: US 2017/0299732 A1
(43) Pub. Date: Oct. 19, 2017

(54) APPARATUS AND METHODS FOR MEASURING DELIVERED IONIZING RADIATION

(71) Applicant: The Trustees of the University of Pennsylvania, Philadelphia, PA (US)

(72) Inventors: Alejandro Carabe Fernandez, Drexel Hill, PA (US); Consuelo Guardiola Salmeron, Philadelphia, PA (US); Diana Davila Pineda, Zurich (CH)

(73) Assignee: The Trustees of the University of Pennsylvania, Philadelphia, PA (US)

(21) Appl. No.: 15/511,807

(22) PCT Filed: Sep. 17, 2015
(86) PCT No.: PCT/US15/50653

§ 371 Date: Mar. 16, 2017

Related U.S. Application Data
(60) Provisional application No. 62/051,506, filed on Sep. 17, 2014.

(51) Int. Cl. G01T 1/02; G01N 23/00

(52) U.S. Cl. CPC G01T 1/026; G01N 23/00

(57) ABSTRACT

A dosimeter includes a substrate and a plurality of nanowire pairs located on the substrate. The plurality of nanowire pairs simulate a plurality of human chromosome pairs. A method of determining an effect of delivering ionizing radiation with a dosimeter having a substrate and a plurality of nanowire pairs located on the substrate, wherein the plurality of nanowire pairs simulate a plurality of human chromosome pairs is provided. The method includes the steps of delivering ionizing radiation to the plurality of nanowire pairs; acquiring information relating to the ionizing radiation; and determining, from the information, the effect of the delivered radiation on the plurality of nanowire pairs.

### CROSS REFERENCE TO RELATED APPLICATIONS

This Application is a National Phase Application of PCT Application No PCT/US2015/050653, dated Sep. 17, 2015 which claims priority to U.S. Provisional Patent Application No. 62/051,506, filed Sep. 17, 2014, the disclosure of which is incorporated herein by reference in its entirety for all purposes.

### FIELD OF THE INVENTION

This invention relates to the field of dosimetry and, more particularly, dosimeters and methods of measuring delivered ionizing radiation with a dosimeter.

### BACKGROUND OF THE INVENTION

Radiation dosimetry deals with the measurement of absorbed radiation dose (D) applied in the field of radiation therapy to treat cancer. Absorbed radiation dose is related to the biological effects that the radiation induces within or around the cancerous target-volume. However, D is a non-stochastic and ‘macroscopic’ quantity that becomes meaningless for microscopic and nanoscopic volumes. At the nanometer scale in particular, knowledge of the energy deposition pattern by protons is desirable, however, to determine, e.g., the biological effectiveness of radiation induced cell death. This information is useful in treatment planning systems to be able to biologically optimize the treatment plans in radio/particle therapy. Currently, the majority of this information is not directly obtained but is extracted from Monte Carlo simulations that rely on approximations on how particles interact with matter at the micro/nanoscale.

A nanodosimeter can be used to directly measure energy deposition at the nanoscale. Present nanodosimeters, such as those described by U.S. Pat. No. 6,787,771, and in Garty, G. et al, Wall-less ion-counting nanodosimetry applied to protons. Radiat. Prot. Dosim. 99, 325-330 (2002), Schulte R., et al., Mapping the sensitive volume of an ion-counting nanodosimeter. JINST 1, P04004 (2006), Pszona S. et al., A new method for measuring ion clusters produced by charged particles in nanometre track sections of DNA size. Nucl. Instrum. Meth. Phys. Res. A 447, 601-607 (2000), and D. Nardo L., et al., A detector for track-nanodosimetry. Nucl. Instrum. Meth. Phys. Res A 484, 312-326 (2002), include a gas-filled chamber which operates using gases, such as propane or nitrogen, at low pressures to create target volumes. Such nanodosimeters are able to measure single ions when these particles go through the gas chamber and reach another trigger detector. The data acquisition system registers the arrival time of the ions to the gas chamber counter and the trigger. Then, data are used to assess the frequency of ionization cluster size. This method assumes, however, not only that the radiation interaction processes for the gas chamber are similar to those in tissue-equivalent, but also that the cross-sections are independent of the gas density. Due to limitations inherent from these assumptions, present methods have been successfully applied to only alpha particles and have demonstrated a counting efficiency lower than 60%.

### SUMMARY OF THE INVENTION

Aspects of the invention relate to dosimeters, as well as methods of determining an effect of delivering ionizing radiation with a dosimeter.

In accordance with one aspect, the invention provides a dosimeter including a substrate and a plurality of nanostructures located on the substrate. The plurality of nanostructures simulate a sub-cellular structure.

In accordance with another aspect, the invention provides a dosimeter. including a substrate and a plurality of nanowire pairs located on the substrate. The plurality of nanowire pairs simulate a plurality of human chromosome pairs.

In accordance with another aspect, the invention provides a dosimeter including a substrate and a plurality of nanowire pairs located on the substrate. Each of the nanowires within the plurality of nanowire pairs has a diameter, d, and a length, L, which are equivalent to a corresponding set of dimensions of a subcellular structure selected from the group consisting of human chromosome pairs, histone-wraps, heterochromatin, and condensed chromatin.

In accordance with yet another aspect, the invention provides a dosimeter including a substrate and a plurality of nano-belt pairs located on the substrate. Each of the nano-belts within the plurality of nano-belt pairs has a width, W, a height, H, and a length, L, which are equivalent to a corresponding set of dimensions of a subcellular structure selected from the group consisting of human chromosome pairs, histone-wraps, heterochromatin, and condensed chromatin.

In accordance with still another aspect, the invention provides a method of determining an effect of delivering ionizing radiation with a dosimeter having a substrate and a plurality of nanowire pairs located on the substrate, wherein the plurality of nanowire pairs simulate a plurality of human chromosome pairs. The method includes the steps of delivering ionizing radiation to the plurality of nanowire pairs; acquiring information relating to the ionizing radiation; and determining, from the information, the effect of the delivered radiation on the plurality of nanowire pairs.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a schematic illustration of dose and dose-rate dependence of aberration formation in a human chromosome pair in accordance with the prior art;

FIG. 2a is a schematic illustration of a dosimeter according to aspects of the present invention;

FIG. 2b is a schematic comparison of a subcellular structure and a nanowire pair according to aspects of the present invention;

FIG. 3 is a schematic illustration of a nanowire pair according to aspects of the present invention;

FIG. 4 is a scanning electron microscope image of a nanowire according to aspects of the present invention;

FIG. 5a is a schematic illustration of potential 1-track breaks according to aspects of the present invention;

FIG. 5b is a schematic illustration of potential 2-track breaks according to aspects of the present invention;

FIG. 6 is a flow diagram of a method of determining an effect of delivering ionizing radiation with a dosimeter according to aspects of the present invention; and FIG. 7 is a scanning electron microscope image of portions of a dosimeter according to aspects of the present invention.

### DETAILED DESCRIPTION OF THE INVENTION

Aspects of the invention relate to dosimeters, as well as methods of determining an effect of delivering ionizing radiation with a dosimeter.

The inventors have recognized that it would be useful to provide a nanodosimeter incorporating a semiconductor radiation detector at a nanometer scale, e.g., an array of semiconductor nanowire pairs that simulate the biological size of human subcellular structures in order to produce biophysical data that could be used for treatment planning purposes with particle therapy or for other nanodosimetric proposals. The inventors have also recognized that it would be useful to provide a system that is able to measure not only the spacing between the impinged hits created by one or more ionizing particles within a subcellular structure (such as a chromosome), but also the amount of energy delivered in these ionizing collisions. The inventors have further recognized that it would be useful to provide a nanodosimeter that (i) supports the validity of the physics models implemented in Monte Carlo code; (ii) provides accurate data for radiation biophysics modeling; and (iii) improves the accuracy of the predicted values of RBE in heavy ion radiotherapy.

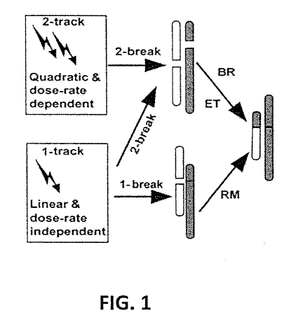

FIG. 1 shows a schematic illustration of the effect of discrete energy deposition by charged particles at the nanometer, i.e., subcellular, scale. FIG. 1 depicts the prior art concept of a “track” structure, which correlates different discrete energy deposition events of the same primary particle. According to this track structure, the dose and dose-rate dependence of aberration formation in a human chromosome pair may be shown.

The distribution of the track structures within the cellular nucleus determines the cell damage, although there are also radio-sensitivity intrinsic factors to the cell such as its repair capacity. It is therefore desirable to characterize this damage by physically measuring the spatial damage distribution pattern of DSB (double strand break) and SSB (single strand break). Since most chromosome aberrations result from the combination between couples of damaged chromosome sites, it is desirable to know where the breaks take place. As depicted in FIG. 1, chromosome aberrations may be characterized as either “1-track action” or “2-track action” locis (Hlatky L. 2002, Radiation-induced chromosome aberrations: Insights gained from biophysical modeling, BioEssays Volume 24, Issue 8, pages 714-723, August 2002). The “1-track action” produces a damage that is linearly proportional to dose and independent to dose rate. The “2-track action” (track pairs) produces a damage proportional to the dose squared.

The frequency of aberrations has been described as a linear-quadratic function of the dose, with the linear term dominating at low doses and the quadratic term dominating at higher doses:

Yield=αD+βD²(D=absorbed dose)

At low doses, both breaks can be generated by the same track, while at higher doses, these two breaks can be caused by two tracks. Whereas for low-linear energy transfer (“LET”), the linear-quadratic relation adequately describes most of the dose-response for the chromosome aberration relations, as LET increases the frequencies of aberrations increase with dose up to an unverified optimum (Geard 1985, Charged particle cytogenetics: effects of LET, fluence, and particle separation on chromosome aberrations, Radiat Res Suppl. 1985; 8:S112-21.) beyond which the relationship becomes uncertain.

The inventive dosimeter and methods are able to characterize track structures at the nanometer, i.e., subcellular level. Through this characterization, to microdosimetric and/or nanodosimetric data, e.g., linear energy (y) and specific energy (z) may be obtained. While reference is generally made to human chromosome pairs as one example of a subcellular structure, one of ordinary skill in the art will understand that the invention encompasses dosimeters and methods which characterize the ionizing dose delivered to other human subcellular structures including, but not limited to, histone-wraps, heterochromatin, and condensed chromatin.

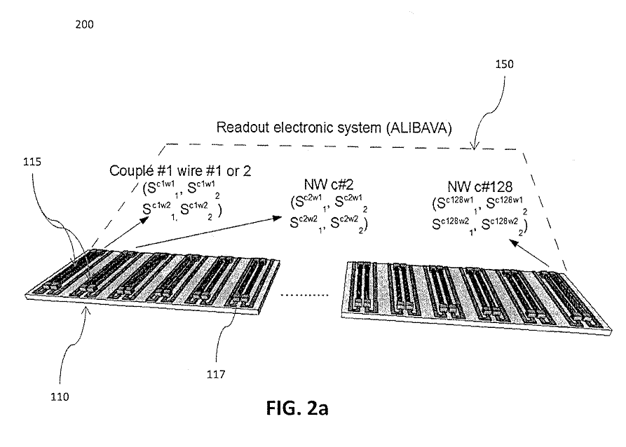

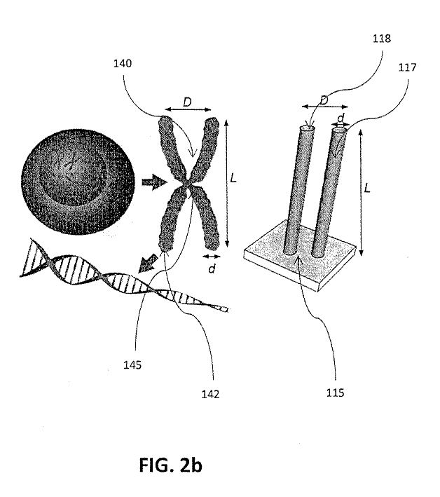

Turning to FIG. 2a, a schematic illustration of a dosimeter 200 according to the present invention is depicted. Dosimeter 200 may be formed on a substrate 110. Exemplary substrate materials include glass, silicon, silicon on insulator (“SOI”), silicon dioxide, mylar, polysiloxanes, or carbon-based polymers including, but not limited to polydimethylsiloxane (“PDMS”), a polyacrlyamide, a polyacrylate, a polymethacrylate or a mixtures thereof.

Dosimeter 200 includes a plurality of nanowire pairs 115 located on substrate 110. Plurality of nanowire pairs 115 may be arranged in an array format. For example, each nanowire pair 115 arranged in parallel or quasi parallel, such as depicted. Because the random arrangement of chromosomes within a cell nuclei, the plurality of nanowire pairs 115, however, do not need to be parallel. One of ordinary skill in the art will understand that a variety of nanostructures other than nanowire pairs may be used within the scope of the present invention. For example, as described below, “nanobelts” may also be used.

In one embodiment, plurality of nanowire pairs 115 are constructed from a semiconductor material. One of ordinary skill in the art will understand that non-limiting examples of suitable semiconductor materials include materials such as silicon, germanium, gallium arsenide, gallium nitride, zinc oxide, indium arsenide, indium phosphide, cadmium sulfide, and combinations thereof.

The nanowire pairs 115 may include a resistive material. The resistive material may comprise, e.g., a coating of oxide material on, an ionic implantation in, or doping of the nanowires 117 in nanowire pairs 115. The resistive layer results in charge division along nanowire 117 and permits localizing charge deposition when an ionizing particle goes through it.

In some embodiments, the plurality of nanowire pairs 115 simulate a subcellular structure such as a plurality of human chromosome pairs. That is, the plurality of nanowires 115 may be manufactured and arranged in a way such that their dimensions are equivalent to the dimensions of the subcellular structure, e.g., human chromosome couples. One of ordinary skill in the art will understand upon reviewing this disclosure that a variety of subcellular structures may be simulated including, but not limited to human chromosome pairs, histone-wraps, heterochromatin, and condensed chromatin. These subcellular structures and others fall within the scope of the present invention.

FIG. 2b illustrates one way in which dosimeter 200 could simulate a subcellular structure such a human chromosome couple. Chromosome couple 140 is formed by two coiled strands of DNA 142 joined at a centromere 145. Each coiled strand of DNA 142 has a diameter, d, an axial length, L, as well as a distance, D, between coiled strands of DNA 142. For example, in an average sized human chromosome pair, d may be approximately 300 nm and L may be approximately 10 μm. Similarly, in dosimeter 200, the plurality of nanowire pairs 115 has a distance, D, between the nanowires 117 in the nanowire pair 115 and, within each nanowire pair 115, each of the nanowires 117 has a diameter, d, and an axial length, L, equivalent to the corresponding set of dimensions in a human chromosome pair. Thus, the volume, V, of nanowire pair 115 is equivalent to that of chromosome couple 140.

Nanowire 117 may be synthesized as a nanoROD. The nanoROD volume may be modeled as cylindrical to simulate the geometry of a chromosome. One of ordinary skill in the art will recognize that other modeling geometries may be desirable to simulate other subcellular structures. For example, a nano-“belt” may be modeled as a cuboid having a width, W, a height, H, and an axial length, L.

NanoROD synthesis may be conducted using a catalytic nanoparticle. That is, nanowire 117 may be “grown” using a catalytic nanoparticle. Initially, islands of semiconductor material may be defined over the silicon dioxide layer of a SOI wafer substrate or over a silicon dioxide wafer. Semiconductor nanowires may then be grown using a source of semiconductor such as gas or powders (e.g. SiH₄, CdSe, GeH₄ etc.) under controlled conditions with the presence of catalyst nanoparticles, e.g. Au. Catalyst nanoparticles provide nucleation sites where the semiconductor nanowires grow. The diameter of these catalyst nanoparticles define the diameter of nanowire 117, which is comparable to the biological diameter scales of chromosomes. The length of nanowire 117 may be defined by controlling the time of the growth. Nanowire 117 can then be controllably drop cast onto substrate 110 generating a device with the required distribution (e.g. a plurality of nanowire pairs 115 that simulates the chromosome-pair distribution inside the cell nuclei).

Nanowire 117 may also be harvested from a nanowire solution obtained by ultrasonification of a semiconductor wafer in an aqueous solution. In one embodiment, nanowire 117 may be formed by covering substrate 110 with a nanowire solution.

A plurality of nanowires 117 may then be arranged into a plurality of nanowire pairs 115 which simulate a plurality of human chromosome pairs.

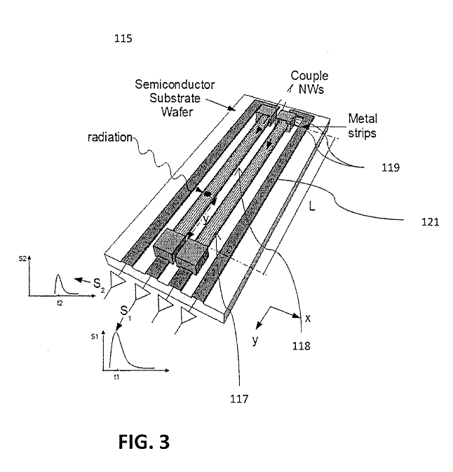

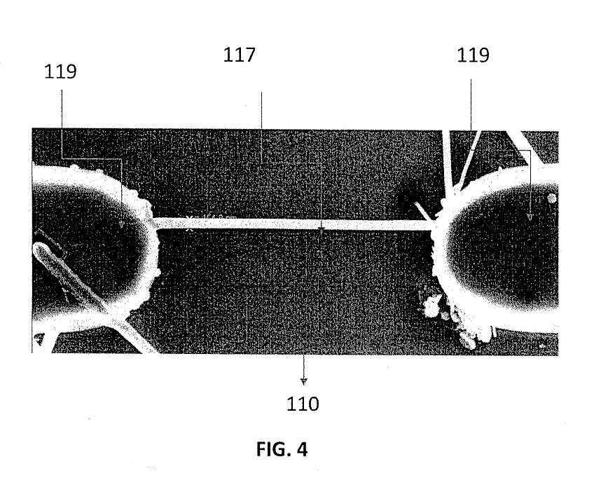

Turning to FIG. 3, once nanowires 117 have been selectively grown, harvested, or patterned, electron beam lithography can be used to specifically pattern the metal strips 121 to define the electrical contacts between the nanowires. FIG. 4 shows a scanning electron microscope image of a silicon nanowire of 10 μm length and 155 nm diameter whose opposite sides are joined to metal strips to read the signal coming from the nanowire.

One of ordinary skill in the art will understand that, among other fabrication methods, the inventive dosimeter may be fabricated using the VLS (vapor-liquid-solid) growth mechanism and the galvanic displacement method. These fabrication methods are used for tuning the uniformity size, distribution and surface structure of the synthesized nanowires. Galvanic displacement may also be used for deposition of metal strips 121.

In one embodiment, the catalytic nanoparticle remains in contact with one or both nanowires in the nanowire pair 115. For example, the catalytic nanoparticle may remain on nanowire 117.

Turning back to FIG. 3, a Schottky barrier may form lengthwise along nanowire pair 115 as a result of the remaining catalytic particle and/or the addition of electrodes 119. In this manner, a charge-depleted volume along nanowire 117 is created when nanowire pair 115 is polarized with an appropriated bias. Metal strips 121 are connected to a data acquisition unit (FIG. 2a, item 150) by means of metal wire bonding or metal needle probes in order to assess the current of nanowire 117. One exemplary data acquisition unit is the AliBAVa System (AliBAVa, Barcelona, Spain), which is a portable electronic readout system for radiation/particle detection.

When radiation hits nanowire 117, it ionizes the nanowire material generating electron-hole pairs that drift up to metal electrodes 119, where an electric signal is created and read as an analogic signal that will be collected by the data acquisition unit 150. Electrodes 119 on nanowire 117 are joined to metal strips 121 on opposite sides to read the signal coming from each side of nanowire 117. As depicted, the resistive nanowires 117 and 118 each provides two signals, i.e., S₁ and S₂. For example, S₁ is read from electrode 119 on one end of nanowire 117 and S₂ is read from electrode 119 on the opposite end of nanowire 117. Similarly, two separate signals S₁ and S₂ are read from each electrode 119 end of nanowire 118. The measurements of S₁ and S₂ᵢ for each nanowire pair, permits the determination of one or more of the location of the ionizing radiation on one or more of the plurality of nanowire pairs, the frequency of the ionizing radiation, and the amount of the ionizing radiation.

The number of nanowire pairs 115 depends on the number of sub-cellular structures that are simulated, which is limited to the number of input channels that data acquisition unit 150 can support.

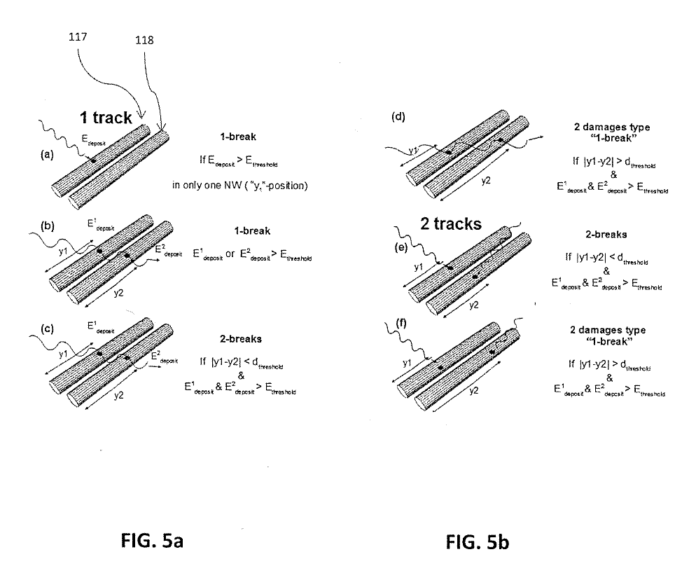

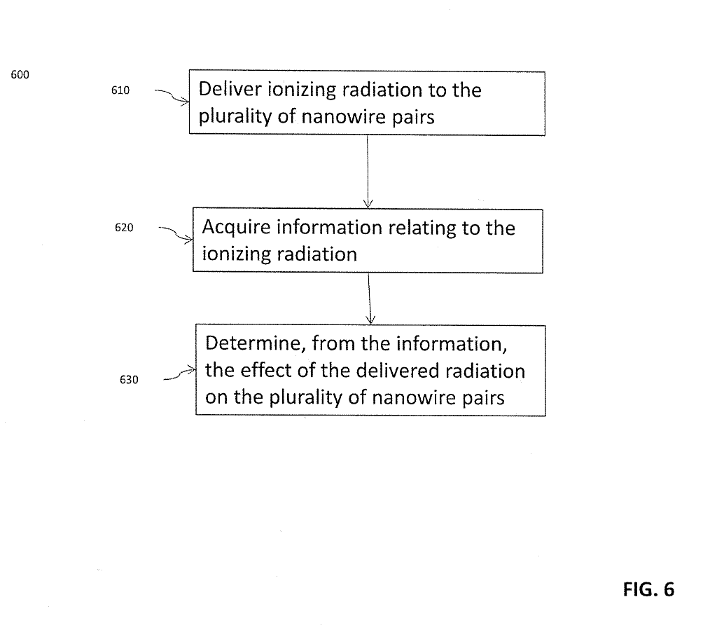

FIGS. 5a and 5b depict the effect of ionizing particles impinging over the plurality of nanowire pairs 115. As ionizing particles impinge over nanowire pair 115 and ionize the semiconductor material, electron-hole pairs are generated that are collected by the dosimeter 200 as a charge current, which allows quantification of the energy deposited by the radiation. The total number of e-h pairs created is proportional to the energy transmitted by the radiation to the semiconductor. In addition to the microdosimetric and/or nanodosimetric quantities that may be characterized such as, e.g., linear energy (y) and specific energy (z), the whole energy deposited in a plurality of nanowire pairs that is equivalent to a the target mass (i.e. total delivered dose in that mass volume) may be also quantified.

If an electric field is applied, the charge carriers created by the radiation are separated by the electric field and drift through the depleted volume of the semiconductor without suffering recombination to the electrodes. These e-h pairs induce an image charge on the electrodes 119 that is integrated, resulting in a current pulse that is processed in an external pre-amplifier in data acquisition unit 150, and thus the energy of the incident radiation can be found. In radiation semiconductor detectors used as 1-D position-sensitive sensors in nuclear or particle physics tracking systems, position-detectors are manufactured starting from basic planar diodes and dividing one of their electrodes into parallel and thin micro-strips, which form independent diodes themselves. An insulating layer (e.g. grown oxide layer) between these micro-strips is required to maintain isolation between them, and in turn the micro-strip electrodes are covered by metal contacts which pass over the implants of the detector and are connected to a readout electronic system. Thereby, segmentation in parallel micro-strips makes the device sensitive to the position along the direction transversal to the strip length when an ionizing particle impinges over it. If these contacts are made with a metal alloy, they allow the propagation of the induced signal with barely any attenuation in the signal amplitude, independently from the point along the metal contact where the particle impacts. Additionally, two-dimension position-sensitive radiation detectors may be manufactured using complex microtechnology double-sided processing (2D microstrip and drift detectors) or pixel detectors (two-dimensional diode arrays and electronics built with the same pixel structure as the sensor on a separate board, which processes individual readouts by each pixel).

Radeka demonstrated that if an electrode is made of a resistive material instead of metal, with metal contacts at its ends to connect it to the read-out electronics, it acts as a diffusive RC line, i.e. the amplitude of the signal generated by the impinging particle suffers attenuation during its propagation towards the electronic contacts and an increase of the rise time of the propagating signal is observed the further the pulse travels (Radeka 1974). The longitudinal coordinate of the signal generation point, i.e. particle position when it impinges on the strip, linearly depends on the collected charge normalized to the sum of the charges collected in opposite electrodes as follows:

$$y = \frac{L • {S}_{2}}{{S}_{2} + {S}_{1}} \qquad ( 1 )$$

Where S₁ and S₂ are the collected signal amplitudes at both ends of the electrodes and L the resistive strip length. Although this charge division method has been used for very long microstrip sensors (several tens of centimeters), no similar study has been published for smaller scales so far.

If an ionizing particle impinges over a nanostructure such as nanowire pair 115, one or two signals will be generated in the pair

(S^{wire1}1, S^{wire1}2 and S^{wire2}1, S^{wire2}2 for the nanowire 117 and nanowire 118 respectively). The generated signal(s) not only indicate the deposited energy of the incident particle, but also the exact 2D-position, i.e. (x,y) coordinates indicating where a “1-track action” is formed. If that same particle interacts with the adjoining NW of the same couple, it brings another (x′, y′) coordinate pair. Depending of the distance between both y-y′ coordinates, it could denote a “2-breaks” or “1-break.”: The sum of both signals for each nanowire pair, i.e. S1+S2 for a first nanowire pair and/or a second nanowire pair, permit the characterization of microdosimetric/nanodosimetric data as described above.

In one embodiment, data acquisition unit 150 is configured to determine, based on the obtained information and an energy threshold for each of the plurality of nanowire pairs, a break type for each of the plurality of nanowire pairs. FIG. 5a depicts the type of breaks 1-track may generate: (a) 1-break, provided the deposited energy (Edeposit) by such ionizing particle is higher than a threshold (Ethreshold), which is the minimum energy necessary to produce a chromosome break; (b) 1-break, provided one of the Edeposit in one NW is higher than Ethreshold; (c) 2-breaks, provided the spacing (|y1-y2|) between such chromosome breaks is lower than a minimum distance (dthreshold) and both Edeposit are higher than Ethreshold; (d) 2 damages type 1-break each one, provided the spacing (|y1-y2|) between such chromosome breaks is higher than dthreshold and both Edeposit are higher than Ethreshold. FIG. 5b depicts the type of breaks 2-tracks may generate: (e) 2-breaks provided |y1-y2| is lower than dthreshold and both Edeposit are higher than Ethreshold; (f) 2 damages type 1-break each one, provided |y1-y2| is higher than dthreshold and both Edeposit are higher than Ethreshold.

In an exemplary embodiment, the data acquisition unit 150 is configured to indicate a break type. The break type may be one of the following options: no break, 1 break, and 2 breaks.

The data acquired by data acquisition unit 150 are processed using a programming framework to measure the 2D-positions in which the ionizing radiation hits each nanowire 117 and 118 of a nanowire pair 115. Here, the data acquisition unit may be configured to correlate the break type with an effect on the plurality of human chromosome pairs. The effect may be an indication of the presence or an extent of damage to the plurality of human chromosome pairs. The 2D positions are correlated with the spacing between them and thus with the different degrees of chromosome breaks (damaged genotypes). Depending on the type of chromosome breaks, the probability of cellular survival may be estimated provided other cell repair factors, which in turn depends on the line cell type, are known.

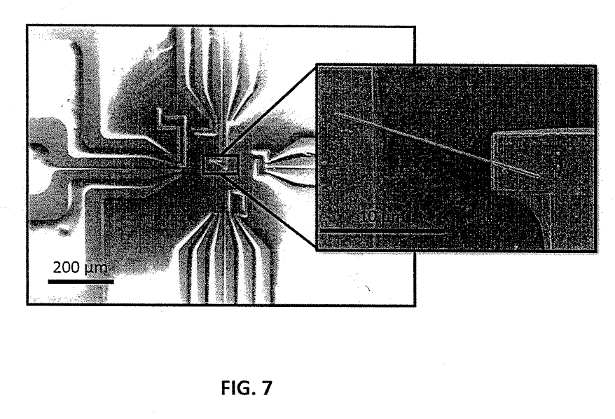

Turning to FIG. 6, a flow diagram depicting selected steps of a process 600 for determining an effect of delivering ionizing radiation with a dosimeter (e.g., dosimeter 200; FIG. 2b) having a substrate and a plurality of nanowire pairs located on the substrate, wherein the plurality of nanowire pairs simulate a plurality of human chromosome pairs according to aspects of the invention is shown. It should be noted that, with respect to the methods described herein, it will be understood from the description herein that one or more steps may be omitted and/or performed out of the described sequence of the method (including simultaneously) while still achieving the desired result.

In step 610, ionizing radiation is delivered to a plurality of nanowire pairs (e.g. plurality of nanowire pairs 115; FIG. 2a). The ionizing radiation may be delivered to the dosimeter (e.g., dosimeter 200; FIG. 2b) while planning a treatment. Alternatively, the ionizing radiation may be delivered to the dosimeter during the treatment of a patient.

In step 620, information is acquired relating to the ionizing radiation. This information may be obtained by a data acquisition unit (e.g., data acquisition unit 150; FIG. 2b). The information may include one or more of the location of the ionizing radiation on one or more of the plurality of nanowire pairs, the frequency of the ionizing radiation, and the amount of the ionizing radiation. As described above, this information may be obtained by measuring the signals S₁ and S₂ of the plurality of nanowire pairs (e.g., nanowire pairs 115; FIG. 2b) resulting from the delivery of ionizing radiation.

The data obtained from step 620 relates to the particular semiconductor material used as a nanostructuture. To account for the differences between materials, a material factor correction may be determined in order to match the material with the corresponding sub-cellular tissue equivalent (e.g., typically water).

In step 630, the effect of the delivered radiation upon the plurality of nanowire pairs (e.g., nanowire pairs 115; FIG. 2b) is determined. As described above, a data acquisition unit (e.g., data acquisition unit 150; FIG. 2b) may be configured to determine, based on the obtained information and an energy threshold for each of the plurality of nanowire pairs, a break type for each of the plurality of nanowire pairs. The break type may be one of the following types: no break, 1 break, and 2 breaks.

Subsequent to the determination of a break-type, an additional step of correlating the break type with an effect on the plurality of human chromosome pairs may be performed.

A high resistivity of the doped semiconductor implant itself (and equipped with metal pads at the ends) can provide a resistive material volume. For a semiconductor nanowires suitably doped, Radeka's formulation of resistive charge division could be used to obtain high spatial resolution in the localization of the delivered energy by the radiation. In conventional microstrip detectors, the metal contacts of the strips extend over the length of the implants and each one is connected to a read-out channel. When a particle crosses the detector, the induced signal along the coupling electrode does not suffer attenuation, i.e. the signal amplitude does not depend on the particle impinging point along the electrode direction. In contrast, if the electrode is a resistive material instead of metal (with metal contacts at its ends to connect it with the data acquisition unit), it acts as a diffusive RC line, i.e the signal amplitude suffers attenuation during its propagation towards the electronic contacts and there is an increase of the rise time of the propagating signal the further the pulse travels. Hence, the longitudinal coordinate of the signal generation point linearly depends on the collected charge normalized to the sum of the charges collected in opposite electrodes as follows:

$$y = \frac{L • {S}_{2}}{{S}_{2} + {S}_{1}}$$

Where S₁ and S₂ are the collected signal amplitudes at both ends of the electrodes.

The inventive dosimeter and methods of determining an effect of delivering ionizing radiation with a dosimeter can be used to provide real time analysis relating to the dose of radiation received by e.g., a human subject. For example, the inventive dosimeter could be a remote unit in telemetric communication with a back end monitoring station. The remote unit could be worn or carried by a subject such as an astronaut, pilot, or emergency response personnel. Dosimeter 200 could send information relating to ionizing radiation detected and/or quantified back to the monitoring station for further processing. In response to the information, the monitoring station could send a warning signal, such as an alert or audible message, back to the subject to notify the subject of exposure to potentially dangerous levels of ionizing radiation.

### EXAMPLES

The following examples are included to demonstrate the overall nature of the present invention.

Samples were prepared using a (100) single crystal silicon wafer. A 1 μm-thick thermal oxide layer was grown on the wafer to isolate the nanowires from the Si substrate. Metal contacts and alignment marks were then patterned through direct laser writing (DLW) lithography followed by the deposition and lift-off of a Cr/Au layer with a thickness of 3 nm and 100 nm respectively. At this point the wafer was diced to perform the dispersion and contact of nanowires at a chip level.

Size-controlled p-type silicon nanowires (Si NWs) with diameters of 84.4+24.7 nm and lengths of 16.7±0.9 μm were grown on (111)-oriented silicon substrates by using the vapor-liquid-solid (VLS) technique, which allows for high-density epitaxial growth of nanowires on free silicon surfaces using catalytic Au nanoparticles as mediators. The Au seed catalysts needed for the VLS process were deposited on the (111) substrates by using a solution of 50 nm colloids in a citrate. Samples were first cleaned and the native oxide was removed by dipping the samples in buffered oxide etchant (BOE). A poly-L-lysine solution, which positively charges the surface of the sample to which it is applied and helps preventing agglomeration of the colloids, was deposited on the substrates for 1 minute. This was followed by the deposition of the colloids solution, with a negative charge, for a period of 1 minute. After this process, the nanowires were grown by placing the substrates with the deposited colloids in a low pressure chemical vapor deposition (LPCVD) system at 630° C. and 9 mbar using 50 sccm of 10% SiH4 in H2 as the silicon gas precursor, 0.5 slm of H2 as the diluent gas and 10 sccm of 100% HCl liquefied gas to control gold migration and decrease the speed of 2D silicon deposition by surface chlorination. In-situ doping of the nanowires was carried out by flowing 50 sccm of 3% B2H6 in He to achieve p-type nanowires.

After the growth of the nanowires, the substrates with the nanowires were placed in an US bath to detach them from the substrate obtaining in this way a solution consisting of individual SiNWs and isopropanol. This solution was then dispersed on the substrates with pre-patterned contacts. Electrical contact to the nanowires was achieved by a second DWL lithography step followed by the tilted evaporation and lift-off of a 3 nm/300 nm-think Cr/Au layer. FIG. 7 depicts a scanning electron microscope image of aspects of the completed device.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A dosimeter comprising:
a substrate; and
a plurality of nanowire pairs located on the substrate, wherein the plurality of nanowire pairs simulate a plurality of human chromosome pairs.

2. The dosimeter of claim 1, wherein each of the plurality of nanowire pairs has a distance, D, between the nanowires in the nanowire pair and, within each nanowire pair, each of the nanowires has a diameter, d, and an axial length, L, equivalent to a corresponding set of dimensions in a human chromosome pair.

3. The dosimeter of claim 1, wherein the plurality of nanowire pairs are constructed of a semiconductor material.

4. The dosimeter of claim 3, wherein the semiconductor material is selected from the group consisting of silicon, silicon on insulator, indium arsenide, germanium, gallium nitride, zinc oxide, indium phosphide, gallium phosphide, cadmium sulfide, germanium, and gallium arsenide.

5. The dosimeter of claim 3, wherein the plurality of nanowire pairs further comprise a resistive material.

6. The dosimeter of claim 5, wherein the resistive material comprises at least one of a coating of oxide material on, an ionic implantation in, or doping of the plurality of nanowire pairs.

7. The dosimeter of claim 3, further comprising at least one catalytic nanoparticle in contact with one or more of the plurality of nanowire pairs.

8. The dosimeter of claim 7, wherein the contact between the catalytic nanoparticle and the one or more of the plurality of nanowire pairs results in a Schottky barrier.

9. The dosimeter of claim 3, further comprising a data acquisition unit configured to provide information relating to ionizing radiation delivered to one or more of the plurality of nanowire pairs.

10. The dosimeter of claim 9, wherein the information comprises one or more of the location of the ionizing radiation on one or more of the plurality of nanowire pairs, the frequency of the ionizing radiation, and the amount of the ionizing radiation.

11. The dosimeter of claim 10, wherein the data acquisition unit is configured to determine, based on the information and an energy threshold for each of the plurality of nanowire pairs, a break type for each of the plurality of nanowire pairs.

12. The dosimeter of claim 10, wherein the break type is selected from the group consisting of no break, 1 break, and 2 breaks.

13. The dosimeter of claim 11, wherein the data acquisition unit is configured to correlate the break type with an effect on the plurality of human chromosome pairs.

14. The dosimeter of claim 13, wherein the effect is an indication of damage to the plurality of human chromosome pairs.

15. The dosimeter of claim 2, wherein d ranges from 20 nm to 300 nm and L ranges from 1 to 20 μm.

16. A dosimeter comprising:
a substrate; and
a plurality of nanowire pairs located on the substrate, wherein the nanowires within the plurality of nanowire pairs have a diameter, d, and a length, L, which are equivalent to a corresponding set of dimensions of a subcellular structure selected from the group consisting of human chromosome pairs, histone-wraps, heterochromatin, and condensed chromatin.

17. A dosimeter comprising:
a substrate; and
a plurality of nano-belt pairs located on the substrate, wherein the nano-belts within the plurality of nano-belt pairs have a width, W, a height, H, and a length, L, which are equivalent to a corresponding set of dimensions of a subcellular structure selected from the group consisting of human chromosome pairs, histone-wraps, heterochromatin, and condensed chromatin.

18. A method of determining an effect of delivering ionizing radiation with a dosimeter having a substrate and a plurality of nanowire pairs located on the substrate, the plurality of nanowire pairs having a nanowire material, wherein the plurality of nanowire pairs simulate a plurality of human chromosome pairs, the method comprising
delivering ionizing radiation to the plurality of nanowire pairs;
acquiring information relating to the ionizing radiation; and
determining, from the information, the effect of the delivered radiation on the plurality of nanowire pairs.

19. The method of claim 18, wherein the information comprises one or more of the location of the ionizing radiation on one or more of the plurality of nanowire pairs, the frequency of the ionizing radiation, and the amount of the ionizing radiation.

20. The method of claim 19, wherein the determining step comprises determining, from the information, a break type for each of the plurality of nanowire pairs.

21. The method of claim 20, wherein the break type is selected from the group consisting of no break, 1 break, and 2 breaks.

22. The method of claim 21, further comprising the step of correlating the break type with an effect on the plurality of human chromosome pairs.

23. The method of claim 22, wherein the effect is an indication of damage to the plurality of human chromosome pairs.

24. The method of claim 18, further comprising the steps of determining a material factor correction for the nanowire material corresponding to a sub-cellular tissue equivalent and applying the factor.

25. The dosimeter of claim 3, further comprising a plurality of metal-pad in contact with the one or more of the plurality of nanowire pairs, and wherein the contact results in a Schottky barrier.

26. A method of manufacturing a dosimeter, the method comprising:
identifying a length, L, and a diameter, d, corresponding to a human chromosome pair;
providing a semiconductor material in the presence of a catalyst nanoparticle;
growing a plurality of nanowires having the length, L, and the diameter, d;
drop casting the plurality of nanowires onto a substrate;
arranging the plurality of nanowires into a plurality of nanowire pairs which simulate a plurality of human chromosome pairs; and
patterning a plurality of metal connections between the plurality of nanowires.

27. A dosimeter comprising:
a substrate; and
a plurality of nanostructures located on the substrate, wherein the plurality of nanostructures simulate a subcellular structure.

28. The dosimeter of claim 27, wherein each of the plurality of nanostructures has a width, W, a height, H, and an axial length, L, equivalent to a corresponding set of dimensions in a subcellular structure.
The dosimeter of claim 27, wherein the plurality of nanostructures are one or more of nanowires and nanobelts.

29. The dosimeter of claim 27, wherein the sub-cellular structure is selected from the group consisting of human chromosome pairs, histone-wraps, heterochromatin, and condensed chromatin.

30. A method of manufacturing a dosimeter, the method comprising:
identifying a length, L, and a diameter, d, corresponding to a human chromosome pair;
preparing a plurality of nanowires from a nanowire solution
arranging the plurality of nanowires into a plurality of nanowire pairs which simulate a plurality of human chromosome pairs; and
patterning a plurality of metal-connections between the plurality of nanowires.

31. A method of manufacturing a dosimeter, the method comprising:
identifying a length, L, and a diameter, d, corresponding to a human chromosome pair;
covering a substrate with a nanowire solution resulting in a plurality of nanowires;
arranging the plurality of nanowires into a plurality of nanowire pairs which simulate a plurality of human chromosome pairs; and
patterning a plurality of metal-connections between the plurality of nanowires.
